(19) United States
(12) Patent Application Publication
(10) Pub. No.: US 2024/0327648 A1
(43) Pub. Date: Oct. 3, 2024

(54) METHOD OF FORMULATING AN ACTIVE ICE-REPULSING NANO-FILLED COATING

(71) Applicant: Raytheon Company, Waltham, MA (US)

(72) Inventors: Danielle L. Grolman, Holden, MA (US); Wenping Zhao, Glastonbury, CT (US); Laura A. Cuthbert, Austin, TX (US); Derrick J. Rockosi, Lynn, MA (US); Mary K. Herndon, Littleton, MA (US); Peter J. Walsh, Wethersfield, CT (US)

(21) Appl. No.: 18/129,506

(22) Filed: Mar. 31, 2023

(51) Int. Cl. C09D 5/00; C09D 7/40; C09D 7/61; C09D 163/00; C09D 175/04; H01Q 1/42

(52) U.S. Cl. CPC C09D 5/002; C09D 7/61; C09D 7/67; C09D 7/68; C09D 163/00; C09D 175/04; H01Q 1/422

(57) ABSTRACT

An article transparent to radiofrequency (RF) signals includes a substrate and a coating arrangement on the substrate. The coating arrangement includes a primer applied to and in physical contact with the substrate, a topcoat applied to and in physical contact with the primer layer, the topcoat including an organic polymer material, and nanoparticles dispersed throughout one of the primer and the topcoat. A content of the nanoparticles ranges from 0.1 wt % to 10 wt %.

### BACKGROUND

The present disclosure relates generally to protective enclosures for electronic equipment, and more particularly, to anti-icing coatings thereupon.

Radar systems often use arrays of electronic instruments for tracking, guidance, and targeting. Such systems often use electromagnetically transparent covers (i.e., radomes) to protect the instruments. It has been observed that ice formation and accumulation on radome surfaces can result in significant radiofrequency (RF) interference which can have a critical, adverse effect on the system performance and operation. Thus, means for mitigating ice formation are desirable.

### SUMMARY

An article transparent to radiofrequency (RF) signals includes a substrate and a coating arrangement on the substrate. The coating arrangement includes a primer applied to and in physical contact with the substrate, a topcoat applied to and in physical contact with the primer layer, the topcoat including an organic polymer material, and nanoparticles dispersed throughout one of the primer and the topcoat. A content of the nanoparticles ranges from 0.1 wt % to 10 wt %.

A method of preventing ice formation on a radome includes applying a coating arrangement to a surface of the radome. The coating arrangement includes a primer applied to and in physical contact with the surface of the radome, a topcoat applied to and in physical contact with the primer layer, the topcoat including an organic polymer material, and nanoparticles dispersed throughout one of the primer and the topcoat. The method further includes operating an instrument at least partially surrounded by the radome to emit radiofrequency (RF) signals such that the heating of the nanoparticles is induced by the RF signals.

### BRIEF DESCRIPTION OF THE DRAWINGS

FIG. 1 is a schematic illustration of an RF-emitting system including a radome.

FIGS. 2A and 2B are simplified cross-sectional illustrations of alternative ice-protection coatings for a radome.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

This disclosure presents an ice-protection coating arrangement for a radome surface. The coating arrangement includes heat-generating nanoparticles in either the outer topcoat layer or the underlying primer layer. RF signals from the incorporating system (e.g., radar system) induce heating of the nanoparticles which sufficiently heat the radome to prevent ice formation. The nanoparticle content selected is sufficient to generate enough heat while maintaining the RF transparency of the radome. The nanoparticles do not significantly increase the weight of the coating arrangement, and do not require a separate/dedicated source of power or other stimulus to generate heat. The nanoparticles do not impact the overall radar performance or RF properties in the operating bands.

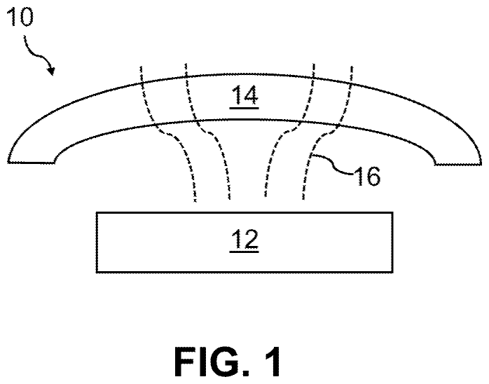

FIG. 1 is a schematic illustration of system 10 which emits RF signals. In an exemplary embodiment, system 10 can be a terrestrial or vehicle-borne radar system having RF-emitting instrument 12 (e.g., antenna array) and protective radome 14 at least partially surrounding instrument 12. Radome 14 protects instrument 12 from environmental factors (e.g., moisture, weather, debris, etc.) while remaining transparent to RF signal emanations 16.

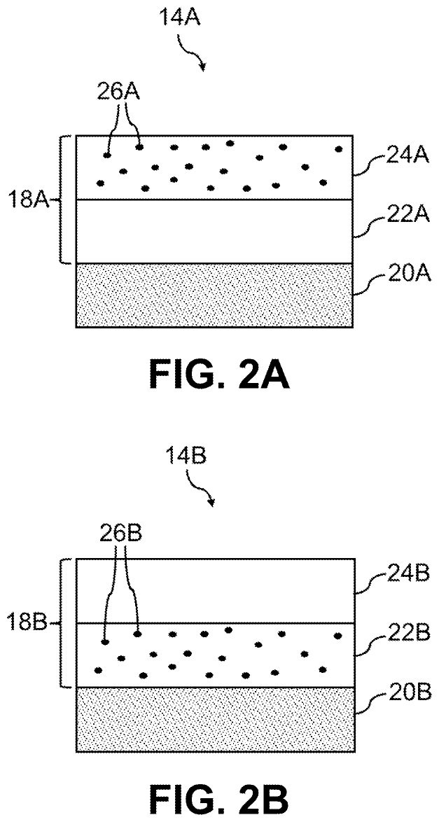

FIGS. 2A and 2B are simplified cross-sectional illustrations of portions of radomes 14A and 14B, respectively, with alternative nanoparticle-based coating arrangements. More specifically, FIG. 2A illustrates coating arrangement 18A on substrate 20A. Substrate 20A can be the outermost surface of a radome 14A receiving coating arrangement 20A. Substrate 20A can be a composite, such as cyanate ester quartz, epoxy glass, or pre-preg foam. Coating arrangement 18A can include primer 22A applied to substrate 20A, and topcoat 24A applied to primer 22A. In one embodiment, primer 22A can be a Mil-Spec epoxy or urethane primer, although other types of primers are contemplated herein. Topcoat 24A can be a hydrophobic or superhydrophobic organic polymer coating.

In the embodiment of FIG. 2A, topcoat 24A also includes nanoparticles 26A. Nanoparticles 26A can be formed from an iron oxide (e.g., magnetite—Fe₃O₄) with paramagnetic properties such that nanoparticles 26A can generate heat within topcoat 24A when subjected to RF radiation as is discussed in greater detail below. In an alternative embodiment, nanoparticles 26 can be formed from gold. Nanoparticles 26A can vary in material type, geometry, aspect ratio and/or particle size. Average particle size can generally range from 5 nanometers to 500 nanometers, while in some embodiments, range from 10 nanometers to 20 nanometers, and in other embodiments, range from 100 nanometers to 200 nanometers. In one embodiment, material type and/or particle size distribution can be generally homogeneous, while in an alternative embodiment, material type and/or particle size distribution can be varied. With any embodiment, the nanoparticle characteristics should be optimized for uniform heat generation. The nanoparticle content of topcoat 24A can range from 0.1 percent by weight (wt %) to 10 wt %, and more specifically, from 0.1 wt % to 1.0 wt %.

During operation of system 10, one or more instruments 12 associated with radomes 14A transmit RF signal emanations 16. The materials of substrate 20A and coating arrangement 18A, including nanoparticles 26A, are transparent to (i.e., do not interfere with) RF signal emanations 16. However, exposure to RF signal emanations 16 induces localized heating of nanoparticles 26A, and thereby topcoat 24A. The heat generated by nanoparticles 26A can reduce or prevent the formation of ice on radome 14A. Further, the heating function of nanoparticles 26A requires no additional stimulus (e.g., applied form of energy) beyond RF signal emanations 16, and is therefore incidental to the normal operation of system 10. Nanoparticles 26A are ideally evenly dispersed and distributed through topcoat 24A to produce even heating of radome 14A.

FIG. 2B illustrates substrate 20B coated with coating arrangement 18B. Substrate 20B can be substantially similar to substrate 20A of FIG. 2A. Coating arrangement 18B includes primer 22B applied to substrate 20B and topcoat 24B applied to primer 22B. Primer 22B and topcoat 24B are substantially similar to primer 22A and topcoat 24A, except that in coating arrangement 18B, nanoparticles 26B are instead incorporated into primer 22B. Nanoparticles 26B can be substantially similar to nanoparticles 26A with respect to material, particles size, content, and mechanism of generating heat. The embodiment of FIG. 2B may be preferred in systems where color change within the topcoat is not desirable, as heat generation of nanoparticles embedded in the topcoat (i.e., topcoat 20A) has been experimentally observed to alter (e.g., darken) the topcoat based on the color of the nanoparticle base material color and/or nanoparticle content. Such applications include those in which the system should ideally visually blend in with its surroundings. Nanoparticles 26B are ideally evenly dispersed and distributed through primer 22B to produce even heating of radome 14B.

Coating arrangements 18A and 18B can be applied to respective substrates 20A and 20B using a spray coating technique in an exemplary embodiment. With respect to coating arrangement 18A, primer 22A can be applied to substrate 20A via spray coating and allowed to cure. Nanoparticles 26A can be added to the organic polymer material of topcoat 24A as a dry nanopowder or dispersed in solution, forming a stable liquid suspension which can be applied to primer 22A via spray coating. To facilitate particle dispersion within topcoat 24A, various additives (e.g., solvents, surfactants, and/or dispersants) can be included in the suspension. Nanoparticles 26A can additionally and/or alternatively be functionalized to facilitate dispersion. Mechanical means, such as an agitator in the spraying apparatus can additionally and/or alternatively be used. Coating arrangement 18B can be similarly applied, except that nanoparticles 26B would be mixed with the epoxy of primer 22B, along with any solvents, surfactants, and/or dispersants. In an alternative embodiment, coating arrangements 18A and/or 18B can be applied to respective substrates 20A and 20B using a painting or dip coating technique. It should be noted that the incorporation of nanoparticles and/or additives within the disclosed coating arrangements does not impact adhesion between the primer to the substrate, nor the adhesion of the topcoat to the primer.

### Discussion of Possible Embodiments

The following are non-exclusive descriptions of possible embodiments of the present invention.

An article transparent to radiofrequency (RF) signals includes a substrate and a coating arrangement on the substrate. The coating arrangement includes a primer applied to and in physical contact with the substrate, a topcoat applied to and in physical contact with the primer layer, the topcoat including an organic polymer material, and nanoparticles dispersed throughout one of the primer and the topcoat. A content of the nanoparticles ranges from 0.1 wt % to 10 wt %.

The article of the preceding paragraph can optionally include, additionally and/or alternatively, any one or more of the following features, configurations and/or additional components:

In the above article, an average size of the nanoparticles can range from 5 nanometers to 500 nanometers.

In any of the above articles, the primer can include epoxy or urethane.

In any of the above articles, the organic polymer material of the topcoat can be hydrophobic or superhydrophobic.

In any of the above articles, the content of the nanoparticles can range from 0.1 wt % to 1.0 wt %.

In any of the above articles, the nanoparticles can be dispersed throughout the topcoat.

In any of the above articles, the nanoparticles can be dispersed throughout the primer.

In any of the above articles, the nanoparticles can be formed from iron oxide or gold.

In any of the above articles, the substrate can be formed from a composite.

In any of the above articles, the article can be a radome.

A system includes the above radome, and an RF-emitting instrument.

A method of preventing ice formation on a radome includes applying a coating arrangement to a surface of the radome. The coating arrangement includes a primer applied to and in physical contact with the surface of the radome, a topcoat applied to and in physical contact with the primer layer, the topcoat including an organic polymer material, and nanoparticles dispersed throughout one of the primer and the topcoat. The method further includes operating an instrument at least partially surrounded by the radome to emit radiofrequency (RF) signals such that the heating of the nanoparticles is induced by the RF signals.

The method of the preceding paragraph can optionally include, additionally and/or alternatively, any one or more of the following features, configurations and/or additional components:

In the above method, the nanoparticles can be dispersed throughout the topcoat.

In any of the above methods, the step of applying the coating arrangement can include applying the primer to the surface of the radome, and subsequently, applying the topcoat with the nanoparticles to the primer.

In any of the above methods, the nanoparticles can be dispersed throughout the primer.

In any of the above methods, the step of applying the coating arrangement can include

In any of the above methods, applying the primer with the nanoparticles to the surface of the radome, and

In any of the above methods, subsequently, applying the topcoat to the primer.

In any of the above methods, a content of the nanoparticles can range from 0.1 wt % to 10 wt %

In any of the above methods, the content of the nanoparticles can range from 0.1 wt % to 1.0 wt %.

In any of the above methods, the nanoparticles can be formed from iron oxide or gold.

In any of the above methods, an average size of the nanoparticles can range from 5 nanometers to 500 nanometers.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An article transparent to radiofrequency (RF) signals, the article comprising:
a substrate; and
a coating arrangement on the substrate, the coating arrangement comprising:
a primer applied to and in physical contact with the substrate;
a topcoat applied to and in physical contact with the primer layer, the topcoat comprising an organic polymer material; and
nanoparticles dispersed throughout one of the primer and the topcoat,
wherein a content of the nanoparticles ranges from 0.1 wt % to 10 wt %.

2. The article of claim 1, wherein an average size of the nanoparticles ranges from 5 nanometers to 500 nanometers.

3. The article of claim 1, wherein the primer comprises epoxy or urethane.

4. The article of claim 1, wherein the organic polymer material of the topcoat is hydrophobic or superhydrophobic.

5. The article of claim 1, wherein the content of the nanoparticles ranges from 0.1 wt % to 1.0 wt %.

6. The article of claim 1, wherein the nanoparticles are dispersed throughout the topcoat.

7. The article of claim 1, wherein the nanoparticles are dispersed throughout the primer.

8. The article of claim 1, wherein the nanoparticles are formed from iron oxide or gold.

9. The article of claim 1, wherein the substrate is formed from a composite.

10. The article of claim 9, wherein the article is a radome.

11. A system comprising:
the radome of claim 10; and
an RF-emitting instrument.

12. A method of preventing ice formation on a radome, the method comprising:
applying a coating arrangement to a surface of the radome, the coating arrangement comprising:
a primer applied to and in physical contact with the surface of the radome;
a topcoat applied to and in physical contact with the primer layer, the topcoat comprising an organic polymer material; and
nanoparticles dispersed throughout one of the primer and the topcoat; and
operating an instrument at least partially surrounded by the radome to emit radiofrequency (RF) signals such that the heating of the nanoparticles is induced by the RF signals.

13. The method of claim 12, wherein the nanoparticles are dispersed throughout the topcoat.

14. The method of claim 13, wherein the step of applying the coating arrangement comprises:
applying the primer to the surface of the radome; and
subsequently, applying the topcoat with the nanoparticles to the primer.

15. The method of claim 12, wherein the nanoparticles are dispersed throughout the primer.

16. The method of claim 15, wherein the step of applying the coating arrangement comprises:
applying the primer with the nanoparticles to the surface of the radome; and
subsequently, applying the topcoat to the primer.

17. The method of claim 12, wherein a content of the nanoparticles ranges from 0.1 wt % to 10 wt %.

18. The method of claim 17, wherein the content of the nanoparticles ranges from 0.1 wt % to 1.0 wt %.

19. The method of claim 12, wherein the nanoparticles are formed from iron oxide or gold.

20. The method of claim 12, wherein an average size of the nanoparticles ranges from 5 nanometers to 500 nanometers.
